(19) United States
(12) Patent Application Publication
(10) Pub. No.: US 2015/0295409 A1
(43) Pub. Date: Oct. 15, 2015

(54) MICRO-GRID OPERATION SYSTEM WITH SMART ENERGY MANAGEMENT

(71) Applicant: CHUNG-HSIN ELECTRIC & MACHINERY MFG. CORPORATION, Taoyuan Hsien (TW)

(72) Inventors: Ruiming Zhang, Taoyuan Hsien (TW); Ting-Kuan Li, Taoyuan Hsien (TW); Jr-Rung Chen, Taoyuan Hsien (TW)

(73) Assignee: CHUNG-HSIN ELECTRIC & MACHINERY MFG. CORPORATION, Taoyuan Hsien (TW)

(21) Appl. No.: 14/263,982

(22) Filed: Apr. 28, 2014

(30) Foreign Application Priority Data
Apr. 10, 2014 (TW) 103113185

(51) Int. Cl. H02J 3/02; H02J 7/35

(52) U.S. Cl. CPC H02J 3/02; H02J 7/35

(57) ABSTRACT

A micro-grid operation system with smart energy management including a power supply system, three micro-grids and an energy management unit is provided. The power supply system generates three phase AC power sources. A first micro-grid receives a first-phase AC power source and is coupled to a first load. A second micro-grid receives a second-phase AC power source and is coupled to a second load. A third micro-grid receives a third-phase AC power source and is coupled to a third load. The energy management unit detects the first, second and third-phase AC power sources to generate a first control signal, a second control signal and a third control signal. The power supply system generates at least one of auxiliary power source to at least one of the first, second and third micro-grids according to the first, second and third control signals.

### CROSS REFERENCE TO RELATED APPLICATIONS

This Application claims priority of Taiwan Patent Application No. 103113185, filed on Apr. 10, 2014, the entirety of which is incorporated by reference herein.

### BACKGROUND OF THE INVENTION

1. Field of the Invention

The invention relates to an operation system, and more particularly to a micro-grid operation system with smart energy management.

2. Description of the Related Art

Many conventional management systems only provide power sources to micro-grids. The conventional systems do not manage the qualities of the power sources. When the qualities of the power sources are deteriorated, the power sources can easily damage loads receiving the power sources. For example, the loads may be burned.

### BRIEF SUMMARY OF THE INVENTION

In accordance with an embodiment, a micro-grid operation system with smart energy management comprises a power supply system, a first micro-grid, a second micro-grid, a third micro-grid and an energy management unit. The power supply system generates a first-phase AC power source, a second-phase AC power source and a third-phase AC power source. The first micro-grid receives the first-phase AC power source and is coupled to a first load. The second micro-grid receives the second-phase AC power source and is coupled to a second load. The third micro-grid receives the third-phase AC power source and is coupled to a third load. The energy management unit detects the first-phase AC power source, the second-phase AC power source and the third-phase AC power source to generate a first control signal, a second control signal and a third control signal. The power supply system generates at least one of auxiliary power source to at least one of the first, second and third micro-grids according to the first, second and third control signals.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a micro-grid operation system with smart energy management;

FIG. 2 is a schematic diagram of a reactive power source.

FIG. 3 is a schematic diagram of an exemplary embodiment of an energy management unit; and

FIGS. 4 and 5 are schematic diagrams of other exemplary embodiments of a generation module.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

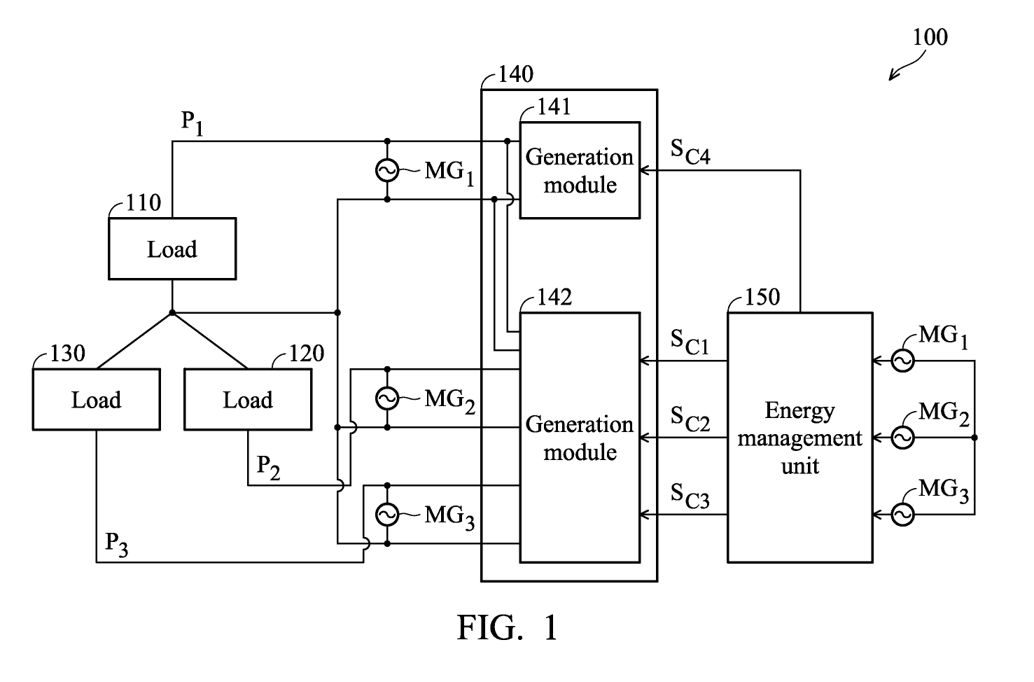

FIG. 1 is a schematic diagram of an exemplary embodiment of a micro-grid operation system with smart energy management. The invention does not limit the kind of operation system 100. For example, the operation system 100 may be a home power-management system, a factory power-management system, a building power-management system, or a base-station power-management system. As shown in FIG. 1, the operation system 100 comprises micro-grids MG₁˜MG₃, a power supply system 140 and an energy management unit 150.

The micro-grid MG₁ is coupled to the load 110 and provides a phase AC power source P1 to the load 110. The micro-grid MG₂ is coupled to the load 120 and provides a phase AC power source P2 to the load 120. The micro-grid MG₃ is coupled to the load 130 and provides a phase AC power source P3 to the load 130. The phase difference between the phase AC power sources P1 and P2 is 120°. The phase difference between the phase AC power sources P2 and P3 is 120°. The phase difference between the phase AC power sources P3 and P1 is 120°. In this embodiment, the loads 110˜130 are AC loads, such as three-phase generator.

The power supply system 140 generates the phase AC power sources P1˜P3. In this embodiment, the power supply system 140 comprises generation modules 141 and 142. The generation module 141 generates the phase AC power source P1 to the micro-grid MG₁ according to a control signal S_{C4}, and the generation module 142 generates the phase AC power sources P2˜P3 to the micro-grids MG₂˜MG₃, but the disclosure is not limited thereto. In another embodiment, the generation module 141 generates two phase AC power sources and the generation module 142 only generates one phase AC power source. In other embodiments, the generation module 141 generates three phase AC power sources and the generation module 142 does not generate any phase AC power source. Regardless of where the generation module 142 generates any phase AC power source, the generation module 142 is capable of generating three auxiliary power sources to the micro-grids MG₁˜MG₃.

The generation module 142 generates at least one of auxiliary power source to at least one of the micro-grids MG₁˜MG₃ according to at least one of the control signals S_{C1}˜S_{C3}. For example, the generation module 142 generates an auxiliary power source to the micro-grid MG₁ according to the control signal S_{C1} to stabilize the quality of the power source in the micro-grid MG₁.

For example, when the power sources of the micro-grids MG₁˜MG₃ are unbalanced, the generation module 142 generates at least one auxiliary power source to at least one of the micro-grids according to the corresponding control signals to balance the power sources of the micro-grids MG₁˜MG₃. Because the generation module 142 is capable of balancing the power sources in the micro-grids MG₁˜MG₃, the loads 110˜130 are not damaged.

The energy management unit 150 detects the voltage state and the current state of each of the micro-grids MG₁˜MG₃ and generates the control signals S_{C1}˜S_{C3} according to the detection results. In one embodiment, the energy management unit 150 calculates the power state of each of the micro-grids MG₁˜MG₃ and generates the control signals S_{C1}˜S_{C3} according to the power state of each of the micro-grids MG₁˜MG₃. In this embodiment, a single energy management unit 150 detects the voltage state and the current state of each of the micro-grids MG₁˜MG₃. In some embodiments, the operation system 100 comprises three energy management units to detect the micro-grids MG₁˜MG₃.

In addition, in this embodiment, the energy management unit 150 directly detects the voltage state and the current state of each of the micro-grids MG₁˜MG₃. In other embodiments, the energy management unit 150 indirectly detects the voltage state and the current state of each of the micro-grids MG₁˜MG₃. For example, the energy management unit 150 utilizes the generation module 142 to detect the voltage state and the current state of each of the micro-grids MG₁˜MG₃ and generate the control signals S_{C1}˜S_{C3}.

The generation module 142 provides at least one auxiliary power source to the micro-grids MG₁˜MG₃ according to the control signals S_{C1}˜S_{C3} to reduce the power source provided from the generation module 141. For example, assume that the energy management unit 150 determines that the power sources of the micro-grids MG₁˜MG₃ are 5 W, 4 W and 3 W, respectively. The energy management unit 150 generates the control signals S_{C1}˜S_{C3} to appropriately adjust the auxiliary power sources generated by the generation module 142 for reducing the power source provided by the generation module 141. In one embodiment, the generation module 142 generates auxiliary power sources to the micro-grids MG₁˜MG₃ and the auxiliary power sources are 3 W, 2 W and 1 W, respectively. Since the generation module 142 provides the auxiliary power source to the micro-grid MG₁, the power source provided by the generation module 141 is reduced from 5 W to 2 W.

In one embodiment, the energy management unit 150 utilizes the control signal S_{C4} to adjust the power source supplied from the generation module 141. The adjusted power source is referred to as an adjustment power source. In this embodiment, the phase AC power source P1 received by the load 110 is the sum of the adjustment power source provided by the generation module 141 and the auxiliary power source generated by the generation module 142. In other words, the power source required by the load 110 is provided by the generation modules 141 and 142.

Additionally, when the generation module 141 is unstable, the power source of the micro-grid MG₁ will be changed such that the load 110 cannot normally work. At this time, the energy management unit 150 controls the generation module 142 according to the variation of the power source of the micro-grid MG₁ such that the generation module 142 provides an auxiliary power source to the micro-grid MG₁ to stabilize the power source of the micro-grid MG₁.

In other embodiments, the energy management unit 150 determines the kinds of loads 110˜130. For example, the energy management unit 150 determines whether each of the loads 110˜130 is an inductive load according to the voltage state and the current state of each of the micro-grids MG₁˜MG₃. When one of the loads 110˜130 is an inductive load, the inductive load causes a reactive power source (or a virtual power source). At this time, the energy management unit 150 utilizes the corresponding control signal to activate the generation module 142 such that the generation module 142 provides an auxiliary power source to improve the reactive power source.

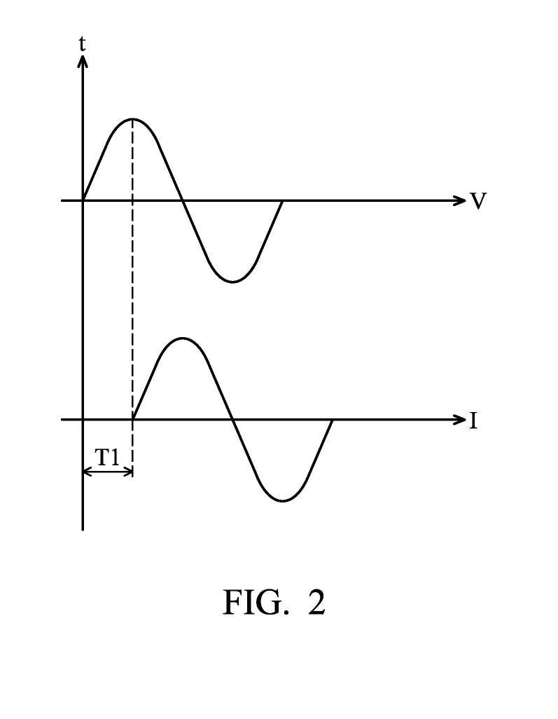

Refer to FIG. 2 and assume that the load 110 is an inductive load. The load 110 first receives a voltage level and then receives a current level. During the period T1, since the load 110 does not receive the current level, the load 110 does not work until receiving the current level. However, the load 110 receives the voltage level and does not work during the period T1. Therefore, a reactive power source is generated in the load 110. When the duration of the period T1 is long, the reactive power source is large.

To avoid excessive power consumption, when the reactive power source exceeds an expected value, the energy management unit 150 generates the control signal S_{C1} such that the generation module 142 provides a current level to the load 110 during the period T1. During the period T1, since the load 110 receives the current level and the voltage level and normally works, the reactive power source is eliminated. In one embodiment, when the generation module 141 can normally provide a current level to the load 110, the generation module 142 stops providing the current level to the load 110. In some embodiments, when the reactive power source does not exceed the expected value, the generation module 142 does not provide the auxiliary power source. When the reactive power source exceeds the expected value, the energy management unit 150 controls the generation module 142 according to the difference between the reactive power source and the expected value such that the generation module 142 provides the auxiliary power source to the load 110.

Refer to FIG. 1 and in this embodiment, the energy management unit 150 is independent from the outside of the power supply system 140, but the disclosure is not limited thereto. In other embodiments, the energy management unit 150 is combined in the power supply system 140 or in the generation module 142.

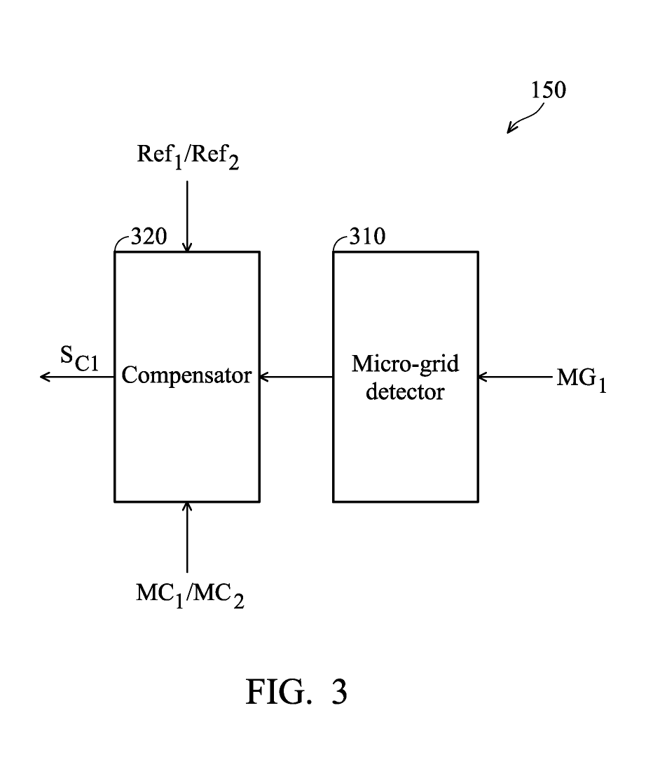

FIG. 3 is a schematic diagram of an exemplary embodiment of an energy management unit. Since the generation methods of the control signals S_{C1}˜S_{C3} are the same, the control signal S_{C1} is provided as an example. In this embodiment, the energy management unit 150 comprises a micro-grid detector 310 and a compensator 320.

The micro-grid detector 310 detects the voltage state and the current state of the micro-grid MG₁ to obtain the voltage curve and the current curve shown in FIG. 2. In other embodiments, the micro-grid detector 310 is capable of detecting the voltage state and the current state of each of the micro-grids MG₁˜MG₃. The invention does not limit the circuit structure of the micro-grid detector 310. In one embodiment, the micro-grid detector 310 comprises at least one voltage detection circuit and at least one current detection circuit.

The compensator 320 determines the duration of the period T1 according to the output of the micro-grid detector 310 and obtains a reactive power source according to the duration of the period T1. When the reactive power source exceeds an expected value Ref₁, the compensator 320 calculates a compensation phase according to the difference between the reactive power source and the expected value Ref₁. The compensator 320 adjusts the phase of a master component MC₁ according to the compensation phase to generate the control signal S_{C1}. In one embodiment, the master component MC₁ is a sine wave.

In other embodiments, the compensator 320 compares the reactive power sources of the micro-grids MG₁˜MG₃ with three expected values. The compensator 320 adjusts the corresponding master phases according to the calculated compensation phases to generate the control signals S_{C1}˜S_{C3}. In one embodiment, the compensator 320 obtains three compensation phases and the three compensation phases are different.

Furthermore, when one of the micro-grids MG₁˜MG₃ transmits the power source to an inductive load, the inductive load causes a harmonic wave such that the power quality of the power sources of the micro-grids MG₁˜MG₃ is affected. Therefore, in this embodiment, the energy management unit 150 determines whether a harmonic wave is generated according to the voltage states of the micro-grids MG₁˜MG₃. When a harmonic wave is generated, the energy management unit 150 compensates for the harmonic wave. Taking FIG. 3 as an example, the compensator 320 compares the voltage state of the micro-grid MG₁ with a pre-determined value Ref₂ to determine whether a harmonic wave is generated.

When a harmonic wave is generated, the compensator 320 generates a compensation component according to the harmonic wave. The compensator 320 combines the compensation component with a master component MC₂ to generate the control signal Sci. In another embodiment, when the compensator 320 obtains a harmonic wave according to the voltage state of the micro-grid MG₁, the compensator 320 compares the harmonic wave with the pre-determined value Ref₂. When the harmonic wave exceeds the pre-determined value Ref₂, the compensator 320 calculates a compensation component according to the harmonic wave and combines the compensation component with the master component MC₂ to generate the control signal S_{C1}. In one embodiment, the master component MC₂ is a sine wave.

In some embodiments, the energy management unit 150 comprises two compensators. One compensator calculates the reactive power source and another compensator calculates the harmonic wave.

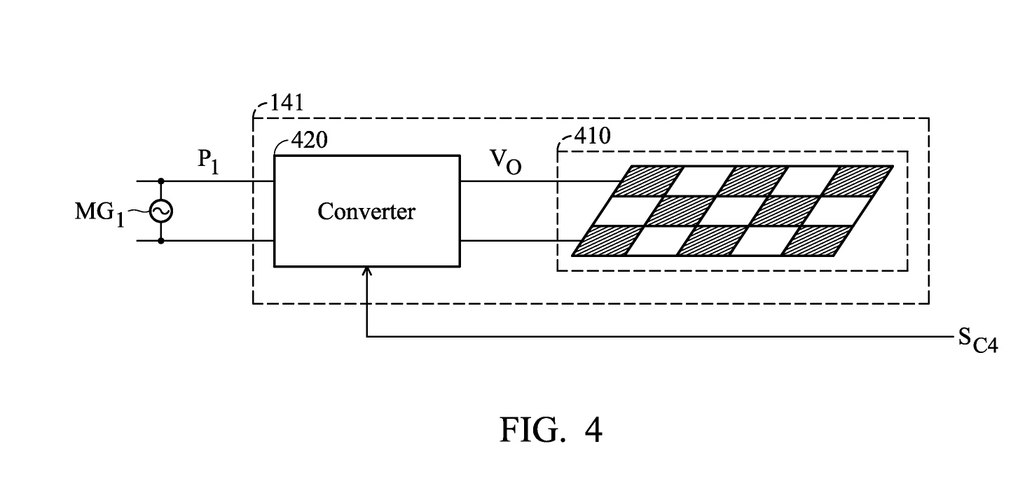

FIG. 4 is a schematic diagram of an exemplary embodiment of a generation module. In this embodiment, the generation module 141 is an AC generation module to generate the phase AC power source P1 and provides the phase AC power source P1 to the micro-grid MG₁. As shown in FIG. 4, the generation module 141 comprises a renewable energy terminal 410 and a converter 420. In other embodiments, the generation module 141 comprises two renewable energy terminals and two converters to generate two-phase AC power sources, such as P1 and P2, to two micro-grids.

The renewable energy terminal 410 generates an output power source Vₒ according to extraneous energy. The invention does not limit the kind of extraneous energy. In one embodiment, the extraneous energy is solar energy or a wind force. In this embodiment, the renewable energy terminal 410 is a photovoltaic (PV) panel. In other embodiment, the renewable energy terminal 410 may be a wind force generator.

The converter 420 transforms the output power source Vₒ according to the control signal S_{C4} to generate at least one of the phase AC power sources P1˜P3. In this embodiment, the converter 420 transforms the output power source Vₒ from an AC format into a DC format and provides the transformed result (i.e. the phase AC power source P1) to the micro-grid MG₁. In one embodiment, the converter 420 is a maximum power point tracking (MPPT).

In other embodiments, if the generation module 141 comprises three AC generation modules, the generation module 141 is capable of generating three phase AC power sources to the micro-grids MG₁˜MG₃. In another embodiment, when the generation module 141 comprises at least one AC generation module and at least one DC generation module, the generation module 141 can generate at least two phase AC power sources to two of the micro-grids MG₁˜MG₃. The invention does not limit the kind of DC generation module. In one embodiment, the DC generation module comprises a fuel cell.

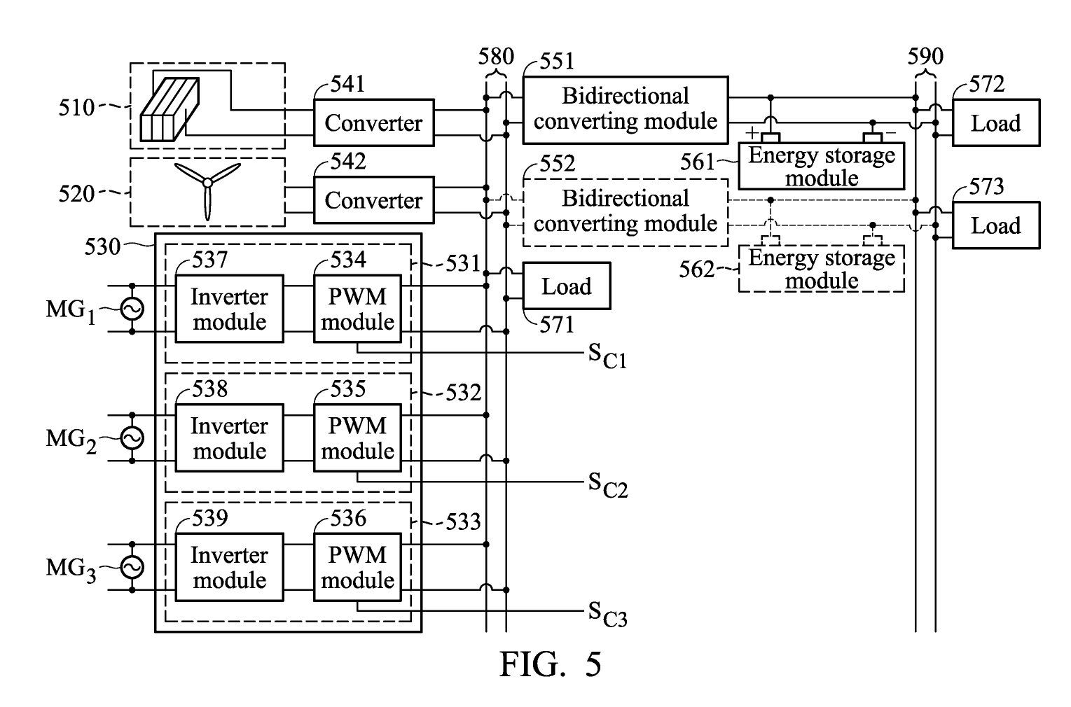

FIG. 5 is a schematic diagram of an exemplary embodiment of a generation module. The generation module 142 comprises a DC generation module 510, an AC generation module 520 and a processing module 530, converters 541,542, a bidirectional converting module 551, an energy storage module 561 and loads 571˜573. In this embodiment, the loads 571˜573 are DC loads. The load 571 is coupled to a high-voltage bus 580 to receive a high operation voltage. The high operation voltage is within 360V˜430V. The loads 572 and 573 are coupled to a low-voltage bus 590 to receive a low operation voltage. The low operation voltage is in 12V˜48V. In other embodiments, the generation module 142 may comprise a high-voltage bus or a low-voltage bus.

The converter 541 transforms the power source generated from the DC generation module 510 and provides the transformed power source to the high-voltage bus 580. In this embodiment, the DC generation module 510 is a fuel cell module to generate a DC power source. The converter 541 is a DC-to-DC converter to transform the power source of the fuel cell module.

The converter 542 transforms the power source generated by the AC generation module 520 and provides the transformed power source to the high-voltage bus 580. In this embodiment, the AC generation module 520 is a wind force generator. The converter 542 is an AC-to-DC converter to transform the AC power source generated by the wind force generator into a DC power source. In one embodiment, the energy management unit 150 generates control signals (not shown) to control the converters 541 and 542 and adjusts the voltage level of the high-voltage bus 580.

The processing module 530 receives and transforms the voltage in the high-voltage bus 580 to provide at least one auxiliary power source to the micro-grids MG₁˜MG₃. In other embodiments, the bi-directional converters 531˜533 transform the power source of the micro-grids MG₁˜MG₃ and provide the transformed results to the high-voltage bus 580. The invention does not limit the internal structure of the processing module 530. In one embodiment, the processing module 530 is a three-phase four-wire bidirectional inverter or an inverter. In this embodiment, the processing module 530 comprises one-phase bidirectional inverters 531˜533.

Since the structures of the bidirectional inverters 531˜533 are the same, the bidirectional inverter 531 is provided as an example. The bidirectional inverter 531 comprises a pulse width modulation (PWM) module 534 and an inverter module 537. The PWM module 534 transforms and outputs the voltage of the high-voltage bus 580 according to the control signal S_{C1}. The inverter module 537 processes the output of the PWM module 534 to generate an auxiliary power source to the micro-grid MG₁.

The bidirectional converting module 551 transforms the voltage level of the high-voltage bus 580 and provides the transformed result to the low-voltage bus 590. In one embodiment, when the bidirectional converting module 551 transforms the voltage level of the high-voltage bus 580, bidirectional converting module 551 charges the energy storage module 561. When the high-voltage bus 580 has unsatisfactory voltage, the bidirectional converting module 551 captures the charger stored in the energy storage module 561 and provides power source to the high-voltage bus 580 to maintain the voltage level of the high-voltage bus 580. In some embodiments, the bidirectional converting module 551 transforms the voltage of the low-voltage bus 590 and provides the transformed result to the high-voltage bus 580.

The invention does not limit the number of the bidirectional converting module 551 and the energy storage module 561. In some embodiments, the generation module 142 comprises a plurality of bidirectional converting modules (e.g. 551 and 552) and a plurality of energy storage modules (e.g. 561 and 562). Additionally, when the DC generation module 510 or the AC generation module 520 is unstable, the bidirectional converting module 551 captures the energy stored in the energy storage module 561 to stabilize the voltage level of the high-voltage bus 580 or the low-voltage bus 590.

Since the processing module 530 provides the corresponding auxiliary power sources to the micro-grids MG₁˜MG₃ according to the control signals S_{C1}˜S_{C3}, the qualities of the power source of the micro-grids MG₁˜MG₃ can be effectively maintained. In one embodiment, when a harmonic wave is generated in the micro-grids MG₁˜MG₃, the energy management unit 150 generates the corresponding control signal according to the harmonic wave. The processing module 530 generates a compensation power source to the micro-grid with the harmonic wave according to the harmonic wave to compensate and adjust the harmonic wave and increase the life of the load.

In another embodiment, when the power source of one of the micro-grids exceeds a pre-determined value, the energy management unit 150 utilizes the control signals S_{C1}˜S_{C3} to control the processing module 530. The processing module 530 provides at least one auxiliary power source to reduce the power source supplied by a power supply system, such as the generation module 141.

Further, when one of the micro-grids MG₁˜MG₃ provides power source to an inductive load, the energy management unit 150 generates the control signal S_{C1}˜S_{C3} to compensate a reactive power source and avoid the power consumption and maintain the phase balance of the three phase AC power sources. In addition, when the power sources of the micro-grids MG₁˜MG₃ are unbalance, the energy management unit 150 utilizes the control signals S_{C1}˜S_{C3} to execute an active power balance operation to avoid the unbalanced power source damaging the loads.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro-grid operation system with smart energy management, comprising:
a power supply system generating a first-phase AC power source, a second-phase AC power source and a third-phase AC power source;
a first micro-grid receiving the first-phase AC power source and coupled to a first load;
a second micro-grid receiving the second-phase AC power source and coupled to a second load;
a third micro-grid receiving the third-phase AC power source and coupled to a third load; and
an energy management unit detecting the first-phase AC power source, the second-phase AC power source and the third-phase AC power source to generate a first control signal, a second control signal and a third control signal, wherein the power supply system generates at least one of auxiliary power source to at least one of the first, second and third micro-grids according to the first, second and third control signals.

2. The micro-grid operation system as claimed in claim 1, wherein the energy management unit detects the power source of the first micro-grid to generate a detection result and obtains a harmonic wave according to the detection result, and when the harmonic wave exceeds a pre-determined value, the energy management unit calculates a compensation component according to the harmonic wave and combines the compensation component with a master component to generate the first control signal.

3. The micro-grid operation system as claimed in claim 2, wherein the master component is a sine wave.

4. The micro-grid operation system as claimed in claim 1, wherein the power supply system comprises:
a first generation module generating at least one of the first-phase AC power source, the second-phase AC power source and the third-phase AC power source; and
a second generation module generating the auxiliary power source according to at least one of the first, second and third control signals, wherein the energy management unit further generates a fourth control signal, the first generation module adjusts at least one of the first-phase AC power source, the second-phase AC power source and the third-phase AC power source according to the fourth control signal to generate at least one of adjustment power source, and the sum of the auxiliary power source and the adjustment power source is equal at least one of the first-phase AC power source, the second-phase AC power source and the third-phase AC power source.

5. The micro-grid operation system as claimed in claim 1, wherein the energy management unit detects the power source of the first micro-grid to generate a detection result and obtains a reactive power source according to the detection result, and when the reactive power source exceeds an expected value, the energy management unit calculates a compensation phase according to the reactive power source and adjusts a master phase according to the compensation phase to generate the first control signal.

6. The micro-grid operation system as claimed in claim 5, wherein the power supply system comprises a pulse width modulation module that generates the auxiliary power source according to the first control signal.

7. The micro-grid operation system as claimed in claim 1, wherein the energy management unit detects the power sources of the first, second and third micro-grids to generate a first detection result, a second detection result and a third detection result, and when one of the first, second and third detection results is unequal to a pre-determined value, the energy management unit generates one of the first, second and third control signals according to one of the first, second and third detection results.

8. The micro-grid operation system as claimed in claim 1, wherein the power supply system comprises:
an AC generation module generating at least one of the first-phase AC power source, the second-phase AC power source and the third-phase AC power source;
a DC generation module generating a DC power source; and
a processing module transforming the DC power source according to at least one of the first, second and third control signals to generate the auxiliary power source.

9. The micro-grid operation system as claimed in claim 8, wherein the AC generation module comprises:
a renewable energy terminal generating an output power source according to an extraneous energy; and
a converter transforming the output power source to generate one of the first-phase AC power source, the second-phase AC power source and the third-phase AC power source.

10. The micro-grid operation system as claimed in claim 9, wherein the extraneous energy is a solar energy or a wind force.
